(19) United States
(12) Patent Application Publication
(10) Pub. No.: US 2023/0373006 A1
(43) Pub. Date: Nov. 23, 2023

(54) ADDITIVE MANUFACTURING SYSTEM AND METHOD

(71) Applicants: American Lightweight Materials Manufacturing Innovation Institute dba LIFT, Detroit, MI (US); Michigan Technological University, Houghton, MI (US)

(72) Inventor: Gerald C. Anzalone, III, Los Osos, CA (US)

(73) Assignees: American Lightweight Materials Manufacturing Innovation Institute dba LIFT, Detroit, MI (US); Michigan Technological University, Houghton, MI (US)

(21) Appl. No.: 18/318,964

(22) Filed: May 17, 2023

Related U.S. Application Data
(60) Provisional application No. 63/344,269, filed on May 20, 2022.

(51) Int. Cl. B22F 10/25; B22F 10/38; B22F 12/30; B22F 10/85; B22F 10/36; B22F 12/00; B33Y 30/00; B33Y 50/02

(52) U.S. Cl. CPC B22F 10/25; B22F 10/38; B22F 12/30; B22F 10/85; B22F 10/36; B22F 12/38; B33Y 30/00; B33Y 50/02

(57) ABSTRACT

A metal additive manufacturing machine includes a housing, a torch at least partially disposed within the housing, a media, a material, a sensor, and a control system. The media is granular and substantially similar to the material such that it can initiate and maintain an arc, if necessary, and be incorporated into the component. The media forms a flat or topographically featured structure. The material is positioned such that it is melted by the torch and forms a layer of material onto the media. The sensor is configured to measure a first data, where the first data is a distance between the torch and a layer of material. The control system is operably coupled to the sensor and configured to receive the first data and compare the first data to a first data threshold. The control system sends a command to move the torch in a z-direction.

### CROSS-REFERENCE TO RELATED PATENT APPLICATIONS

This application claims the benefit of and priority to U.S. Provisional Patent Application No. 63/344,269, filed May 20, 2022, the entire disclosure of which is incorporated by reference herein.

### BACKGROUND

The present disclosure relates generally to metal additive manufacturing. More specifically, the present disclosure relates to a wire additive manufacturing machine having systems to account for component deformation during the manufacturing process.

Metal additive manufacturing (MAM) processes have become a key manufacturing method for the ability to produce components having complex geometries without a high waste of material. Wire additive manufacturing (WAM) is one technique of MAM. WAM is a process of depositing metal layers on top of one another to form a component, and has fundamentally required the use of a build plate to begin the printing process. The build plate has historically been necessary to minimize distortion of the component resulting from stresses arising from various processes occurring during production (e.g., solidification, solid state phase changes, shrinkage on cooling, etc.).

### SUMMARY

At least one embodiment relates to a metal additive manufacturing machine. The metal additive manufacturing machine includes a housing, a torch at least partially disposed within the housing, a media, a material, a sensor, and a control system. The torch provides energy to melt the material employing any of a number of energy sources. The media is granular and substantially similar to the material such that it can initiate and maintain an arc, if necessary, and be incorporated into the component. The media is positioned beneath the nozzle and expanded over a print area, and the media forms a flat or topographically featured structure. The material is positioned such that it is melted by the torch and forms a layer of material onto the media. The sensor is coupled to the housing via a support. The sensor is configured to measure a first data, where the first data is a distance between the torch and a layer of material. The control system is operably coupled to the sensor and configured to receive the first data and compare the first data to a first data threshold. The control system sends a command to move the torch in a z-direction in response to the first data being outside of the first data threshold.

Another example embodiment relates to a machine configured to produce a metal component. The machine includes a housing, a torch, a media, a material, and an anchor. The torch is disposed parallel to the housing and is at least partially received within the housing. The media is positioned beneath the torch and expands over a print area. The material is at least partially disposed within the torch such that it is melted by the torch and forms a layer of material onto the media. The anchor is at least partially disposed within the media and the metal component. The anchor protrudes laterally from the media or has a surface flush with the exposed surface of the media. The material is layered onto the anchor and media. The anchor is separated from the metal component when the machine is done printing.

Another example embodiment relates to a method of manufacturing a metal component. The method includes providing a wire through a nozzle or orifice onto a granular media where it is melted by a torch. The method further includes translating the torch along a path to create a layer of material. The method further includes providing a sensor positioned distal the torch and configured to measure a distance between the torch and the layer of material or media. The method further includes providing a distance between the torch and the layer of material or media to a controller, and, in response, repositioning the torch to maintain a distance between the torch and the layer of material or media. The wire material is initially layered onto an anchor at least partially disposed through the granular media. The anchor is cut from the metal component when the machine is done printing.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a wire additive manufacturing machine, according to an exemplary embodiment;

FIG. 2 is a perspective view of the wire additive manufacturing machine of FIG. 1, shown in use, according to an exemplary embodiment;

FIG. 3 is an illustration of a generalized torch, according to an exemplary embodiment;

FIG. 4 is a bottom view of a component printed from the wire additive manufacturing machine of FIG. 1, showing an anchor, according to an exemplary embodiment;

FIG. 5 is a side view of a component printed from the wire additive manufacturing machine of FIG. 1, on a flat bed of media, according to an exemplary embodiment;

FIG. 6 is a side view of a component printed from the wire additive manufacturing machine of FIG. 1, on a bed of media, according to an exemplary embodiment;

FIG. 7 is a block diagram of a control system of the wire additive manufacturing machine of FIG. 1, according to an exemplary embodiment; and

FIG. 8 is a block diagram of a method of controlling the wire additive manufacturing machine of FIG. 1, according to an exemplary embodiment.

### DETAILED DESCRIPTION

Before turning to the FIGURES, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a wire additive manufacturing machine includes a housing, a torch, and a material at least partially disposed within the housing. The wire additive manufacturing machine is configured to extrude the material into the heated area produced by the torch, melting it onto a media, in the form of a layer, to build up a component. The granular media may have an anchor at least partially disposed, and protruding upwards from, or substantially flush with the surface of the media. The wire additive manufacturing machine includes a sensor positioned away from the housing and configured to measure a distance between the nozzle and the layered material.

In some embodiments, the sensor sends data to a control system. The control system includes a controller and a memory operably coupled to the controller. The control system is configured to control components of the wire arc additive manufacturing machine (e.g., material feed rate, nozzle speed, nozzle height, melting power, etc.) in response to a sensor feedback. By way of example, the control system may be configured to create, and maintain, ideal manufacturing conditions between the wire additive manufacturing machine and a print volume.

In some embodiments, the wire additive manufacturing machine is operably coupled to a software. The software may be a Computer Aided Manufacturing (CAM) software. The CAM software is configured to calculate the steps of the manufacturing process, and further estimate a component deformation. The component deformation may be calculated based upon a height of the component, a length of the component, a width of the component, an internal structure of the component, a material of the component, etc. The software may provide the component deformation to an operator, where the operator may alter the geometry of the media to compensate for the component deformation.

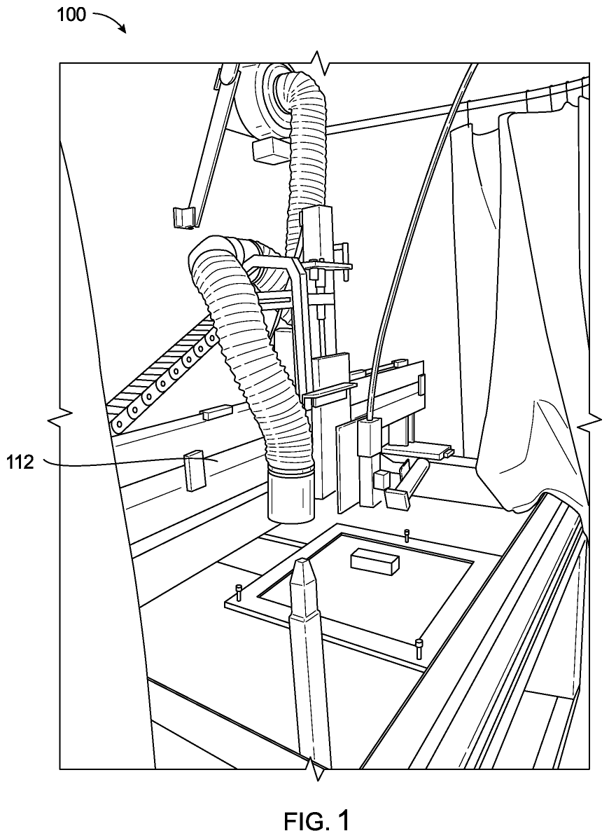

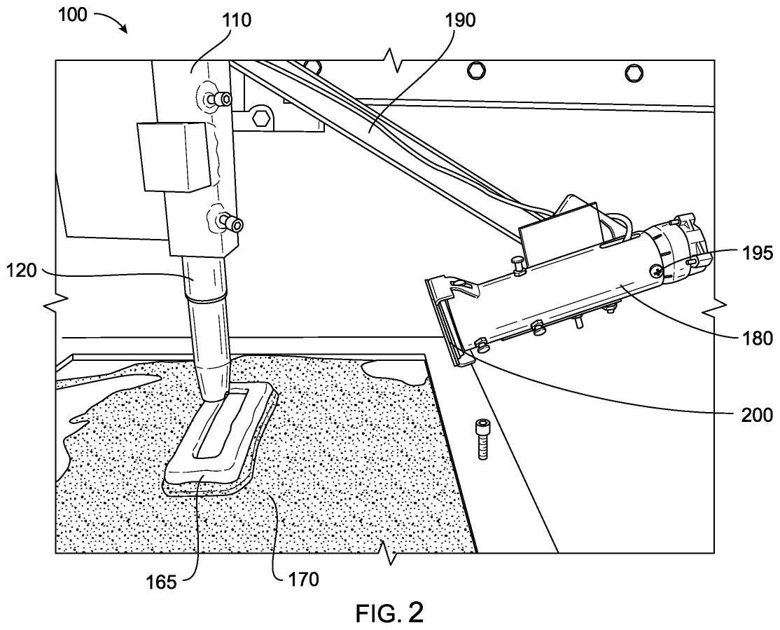

Referring now to FIGS. 1 and 2, a wire additive manufacturing (WAM) machine, referred to herein as machine 100, is shown according to an exemplary embodiment. The machine 100 may be configured for use to print metal components. The component may be comprised of a metallic material (e.g., steel, aluminum, titanium, nickel-based alloys, etc.). The WAM machine described herein may be the same as or similar to any of the WAAM machines as described in PCT Publication No. WO2021/188902, filed Mar. 19, 2021, the entire disclosure of which is incorporated by reference herein.

The machine 100 may be a combination of a metal inert gas (MIG) welder and a motion control system 112 (e.g., robotic, computer numeric control (CNC), etc.). In other embodiments, the machine 100 may be at least one of the MIG welder and the CNC machine 112. The CNC machine 112 may be a 3-axis gantry machine for motion control. In some embodiments, the CNC machine 112 may be a 5-axis machine. In still other embodiments, the machine 100 may be an industrial robot, or of another configuration capable of depositing the metal material.

Referring still to FIGS. 1 and 2, the machine 100 may include a housing 110. The housing 110 may be a cylindrical housing extending along a lateral direction of the machine 100. The housing 110 may be positioned substantially perpendicular (e.g., 5 degrees, 10 degrees, 15 degrees, 20 degrees, etc. from perpendicular) to a build surface. In other embodiments, the housing 110 may be angularly provided in relation to the build surface (e.g., 45 degrees, etc.). The housing 110 may be configured to encase, surround, or protect components of the machine 100 therein, principally, the torch 120. A torch energy source (e.g., arc, plasma, laser, etc.) and a controller may be configured to control material feed rate and may include means for delivering inert shielding gases to the area surrounding the melt pool. The inert gas may be one of carbon dioxide, argon, helium, combination thereof, etc. Inert gasses may be resistant to chemical reactions caused when printing components thus producing an inert atmosphere to create ideal manufacturing conditions within the printing process, further referred to as a shielding zone. In other embodiments, shielding gas may be delivered to the area surrounding the melt pool by a separate nozzle positioned proximate to the torch 120. In still other embodiments, the entire machine 100 may be housed within a sealed vessel that has been purged and filled with inert gas.

Referring still to FIGS. 1 and 2, the machine 100 includes a motion control system 112. The motion control system 112 may include a motor, a bearing, and/or a guide system along which the machine 100 may be selectively repositionable. The guide system may include one or more guide rails that may permit translational movement of at least the housing in at least one of an x-direction, a y-direction, and a z-direction.

The machine 100 includes a torch, nozzle, etc., shown as torch 120. The housing 110 may at least partially receive the torch 120, where the torch 120 may extend laterally downward from the housing 110. The torch 120 may further be a cylindrical, hollow structure configured to provide the gas from a gas controller to a print area. The torch 120 may be configured to translate, via the motion control system, in at least the x-direction, the y-direction, and the z-direction. Additionally or alternatively, the housing 110 may be configured to protect components of the machine 100 from at least one of material splatter, external forces, etc. For example, during a manufacturing process, the housing 110 may be oriented as to reduce the risk of material from splashing up and affecting internal components of the machine 100. Additionally, the housing 110 may be oriented as to direct the gas out of the torch 120 at a particular location. Although not shown, the gas creates the shielding zone when outputted from the torch 120.

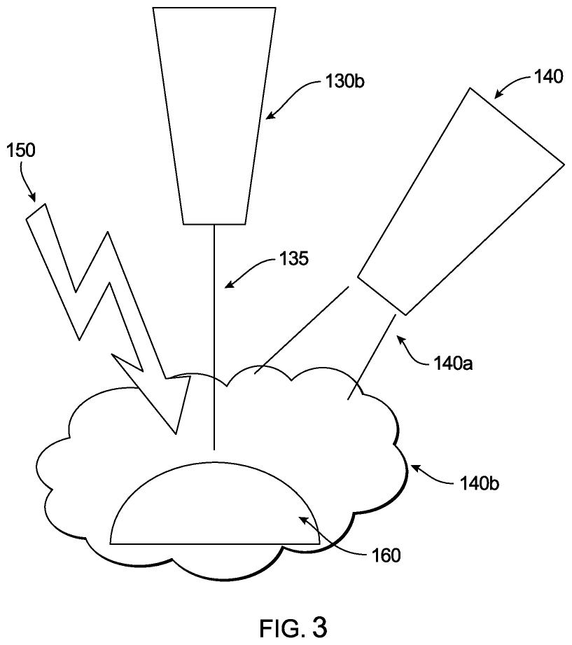

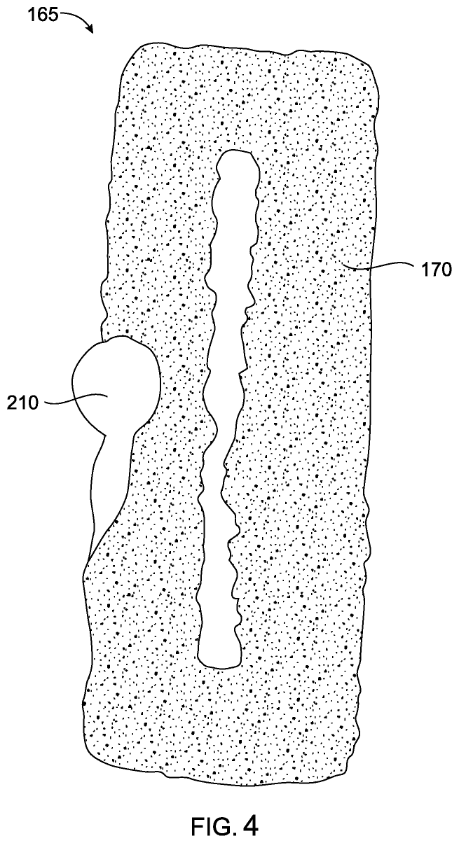

Referring specifically to FIG. 2, the machine 100 may include a sensor 180. The sensor 180 may be coupled to the housing 110 via a support 190. The support 190 may angularly extend from the housing 110 (e.g., 30 degrees from the housing 110, 45 degrees from the housing 110, 60 degrees from the housing 110, etc.). The sensor 180 may be, but not limited to, at least one of an optical sensor, ultrasonic sensor, a proximity sensor, a position sensor, a temperature sensor, a piezo sensor, etc. The sensor 180 may be configured to measure a distance between an end of the material (e.g., material 135 in FIG. 3) and the component (e.g., component 165 in FIG. 4), referred to herein as first data. In other embodiments, the sensor 180 may be configured to measure a distance between an end of the torch 120 and the component or media. In still other embodiments, the sensor 180 may be configured to track the torch 120 to determine a location of the torch 120 against the component 165. In still other embodiments, the sensor 180 may be configured to detect a temperature proximate the torch 120.

Referring still to FIG. 2, the sensor 180 may be at least partially disposed within a sensor housing 195. The sensor housing 195 may be of any geometrical configuration that can house the sensor 180 (e.g., frustoconical, cylindrical, prismatic, etc.). The sensor housing 195 may include a lens, shield, cover, etc., shown as shield 200. The shield 200 may be positioned between the torch 120 and the sensor 180, proximate the sensor 180. The shield 200 may be a protective shield configured to protect the sensor 180 from a brightness of an arc produced. Additionally or alternatively, the shield 200 may be configured to protect the sensor 180 from material splatter during the manufacturing process. The shield 200 may be coupled to the sensor housing 195 via one or more mounting clips. In some embodiments, the shield 200 may be an independent component positioned between the torch 120 and the sensor 180.

Although not shown, the machine 100 may include one or more sensors different from the sensor 180. The one or more sensors may be wire diameter sensors configured to measure a diameter of the material, referred to herein as second data. The one or more sensors may measure the diameter of the material at any location on the path material is introduced along.

As discussed in greater detail herein, the first data from the sensor 180 and the second data from the one or more sensors may be provided to a control system. The control system may utilize the first data and the second data to automatically send a command to move the torch 120 and one or more of the sensors, change a feed rate of the material, change a speed of the torch 120, determine optimum manufacturing parameters, etc.

Referring now to FIG. 3, a generalized depiction of a torch includes a nozzle or orifice, shown as nozzle 130b, for delivering a material 135 to a specific point. An inert gas may be delivered to the same point with a gas nozzle 140 which forms a stream of gas 140a to produce a volume of inert gas 140b that encompasses the area proximal the bottom of the nozzle 130b. Energy 150 is applied to melt the material at the point. A melt pool 160 forms inside the cloud of inert gas 140b. The zone of inert gas displaces atmospheric gases thereby minimizing reactions between the molten metal in the melt pool 160 and atmospheric gases (e.g., oxygen, etc.). In one embodiment, the nozzle 130b and the gas nozzle 140 are a single unit, with material 135 introduced coaxially with the gas 140a and energy 150 is supplied through the material 135 (e.g., gas metal arc welding (GMAW)). In another embodiment, energy 150 is supplied through a non-consumable electrode placed coaxially with the gas nozzle 140 (e.g., gas tungsten arc welding (GTAW)). Additionally or alternatively, energy may be supplied by plasma, laser, etc.

Referring still to FIG. 3, the machine 100 may include a material 135. The material 135 may be a wire. The material may be one of a solid wire or a cored wire. A cored wire may be a wire having a coaxial hollow portion extending within (e.g., pipe, tube, etc.), where alloy elements are positioned within the hollow core to provide the varying component characteristics (e.g., tensile strength, corrosion resistance, weld conductivity, etc.). Additionally or alternatively, the core may contain flux to alter the rheology of the melt pool. Flux may also be added for the purpose of displacing atmospheric gases from the melt pool, augmenting or replacing the inert gas 140b. The material 135 may be that of a steel, aluminum, titanium, nickel-based alloy, or the like. The material 135 may have a diameter of a fraction of a millimeter to several millimeters.

Referring to FIGS. 1-3, the machine 100 may dispense material to form a layered material, shown as component 165. The component 165 may be comprised of substantially the same material as material 135, where the material 135 is dispensed layer by layer to form the component 165. According to an exemplary embodiment, an arc is formed between an end of the material 135 and the component 165, where the material 135 is melted and applied to the component 165 to build up the component 165.

Traditionally, WAM printing has utilized a build plate (e.g., metal plate, etc.) where the material 135 is printed onto the build plate to provide structural support to the component 165 during the manufacturing process. The build plate may have been utilized to absorb stresses introduced to the component 165 during the manufacturing process and prevent component deformation. Although, when the manufacturing process is complete, and the component 165 is removed from the build plate (e.g., grinding, cutting, etc.), the component 165 may show signs of deformation. In some instances, the component 165 may deform out of dimensional tolerances requiring substantial post-processing be performed on the component 165. Referring now to FIGS. 2 and 3, the material 135 may be melted and released on to a bed of media 170. The media 170 may be a granular support media on which an arc may be initiated and maintained, if required. The media 170 may further permit the machine 100 to print overhanging portions. As can be appreciated, the machine 100 may print an overhang at any angle from normal (e.g., surface parallel to the build surface, etc.). Traditionally, metal additive manufacturing (MAM) has had difficulty producing components with a substantial overhang while maintaining dimensional tolerances. Referring now to FIGS. 1-3, the media may form an initial layer upon which the component can be produced, eliminating the need of the build plate and allowing the component 165 to freely deform.

Referring now to FIGS. 2 and 4, the component 165 may be coupled to a support, rod, fastener, protrusion, etc., shown as anchor 210. The anchor 210 may have a small cross section in comparison to a cross section of the base of the component 165. In some embodiments, the anchor 210 may have an equivalent cross section to the cross section of the base of the component 165. In other embodiments, the component 165 may be coupled to multiple anchors 210, where the multiple anchors 210 may be spaced at intervals over the area of the base. The anchor 210 may be held immobile with respect to machine 110 and may be at least partially disposed through at least one of the media 170 and the component 165. The anchor 210 may be located where the manufacturing process begins so the component 165 may be anchored during the manufacturing process. The anchor 210 may be cut, ground, filed, etc. down to a location proximate a surface of the component 165. For example, the anchor 210 may be grinded down where a surface of the anchor 210 resides on a same contact plane to that of a surface of the component 165. As can be appreciated, the removal of a small anchor 210 requires considerably less work than removing a build plate having a cross section larger than the cross section of the base of the component 165. This is particularly relevant with large components having cross sections with dimensions measuring a meter and more, but can also be suitable for applications with dimensions less than a meter.

A single anchor 210 may not absorb any stress introduced to the component 165 during the manufacturing process, permitting unrestricted deformation of the component 165. By way of example, during the manufacturing process, the component 165 may be able to naturally deform, where the anchor 210 rigidly holds the component 165 in place. The result of unrestricted deformation could be a reduction in residual stress and overall improved component properties. In other embodiments, multiple small anchors may be used to rigidly hold the component 165.

Referring to FIGS. 2 and 4, a topography may be introduced into the surface of the media 170 (e.g., a single or many hills or mounds may be formed, etc.). Coupled with the anchor 210, the topography may be structured so as to counter deformation of component 165 occurring during the manufacturing process. According to an exemplary embodiment, the component 165 may initially be printed in a deformed state, where the manufacturing process will further reverse deform the component 165 into the proper shape. That is, the component 165 begins manufacturing in a deformed state antithetical to the deformation that will occur during the manufacturing process, and as more layers of material are applied, the component 165 is deformed into the proper shape. As can be appreciated, the nature of topographic features is dependent upon a calculated amount of component deformation. For example, if the component 165 is calculated to have a large amount of deformation, the slope of the topographic features could be expected to be increased to account for that deformation. Alternatively, if the component 165 is calculated to have a small amount of deformation, the slope could be expected to be decreased to account for that deformation. In another example, the component 165 may be calculated to have a large amount of deformation in multiple areas, where the topography may be substantially similar to the calculated deformation. In other embodiments, the deformation may be determined experimentally.

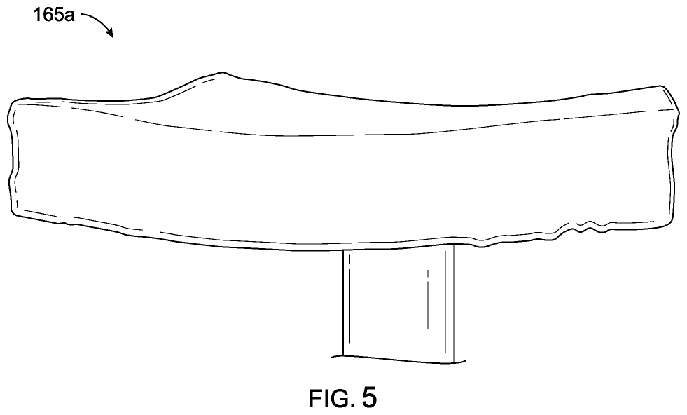

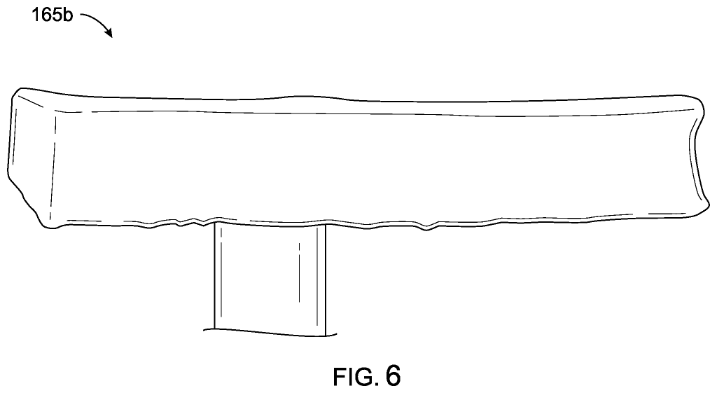

Referring now to FIGS. 5 and 6, the component 165 was printed using (a) a flat bed of media 170, component 165a shown in FIG. 5, and (b) a substantially hemispherical bed of media 170, component 165b shown in FIG. 6. As shown in FIGS. 5 and 6, the manufactured component geometry differs based on the geometry of the media 170. When the component deformation is calculated prior to beginning the manufacturing process, with the component able to freely deform during the manufacturing process, the finished component may be substantially similar to a desired component. The component 165a may be initially deformed at the beginning of the manufacturing process, and thereafter form into the correct geometry as the manufacturing process continues and reverse deform into the component 165b. As can be appreciated, after the manufacturing process is done, the component 165b may still need post processing (e.g., machining, drilling, finishing, etc.) to manufacture the component 165b into the final geometry. In this manner component deformation is determined and accounted for in advance so that the final product deforms into the desired final shape.

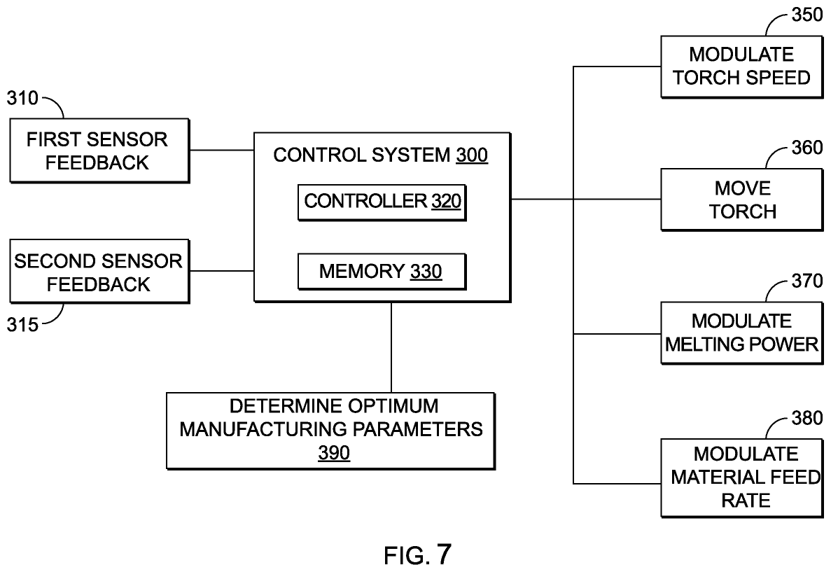

Referring now to FIG. 7, a control system 300 is shown. The control system 300 may be configured to automatically send a command to control components of the machine 100 in response to feedback from the sensor 180. In some embodiments, the components of the machine 100 may be manually controlled in response to receiving feedback from the sensor 180. The control system 300 may receive first sensor feedback 310 and second sensor feedback 315. The first sensor feedback 310 may be at least one of (a) a component layer height, (b) a distance between the torch and the component or media, (c) a temperature, and (d) a torch height. The second sensor feedback 315 may be a material diameter. The control system 300 may include more operating commands than what is disclosed herein. The component layer height may be a distance between adjacent layers of material. In some embodiments, the component layer height may be a distance between the top layer of material and the media 170. The torch speed may be a translational speed of the torch 120 in at least one of the x-direction, the y-direction and the z-direction. The material feed rate may be a rate at which material 135 is being melted by the energy source and applied to either the media 170 and/or the existing layer of material. The torch height may be a distance of the torch 120 to the existing layer of material 135. In some embodiments, the torch height may be a distance of the torch 120 to the media 170. The material diameter may be a diameter of the wire material used for the manufacturing process, prior to the material being directed into the torch (e.g., torch 120).

Referring still to FIG. 7, the sensor feedback 310, 315 may be provided to a controller 320. The controller 320 may receive the sensor feedback, and, in response, send a command to actuate components of the machine 100 in response to the sensor feedback 310, 315. That is, the controller 320 may further be operably coupled to a memory device, shown as memory 330. The memory 330 may store operations of the controller 320 based on the sensor feedback 310. For example, the memory 330 may be configured to receive the component 165 height from the sensor feedback 310 and modify the torch height from the controller 320. In such an example, if the torch 120 is less than a desired distance away from the component 165, the controller 320 may send a command to the torch 120 to translate in the z-direction. As can be appreciated, the controller 320 may send the command to the torch 120 to translate in the z-direction to prevent the torch 120 from crashing into the component 165. According to an exemplary embodiment, when the component 165 may be permitted to freely deform during the manufacturing process, there may be an increased chance for the component 165 to crash into the torch 120. The controller 320 may continuously monitor the sensor feedback 310 to prevent the torch 120 from crashing (e.g., contacting, impacting, etc.) into the component 165 throughout the entire process of the print. In other embodiments, the controller 320 may selectively monitor the sensor feedback 310 based on alternate variables (e.g., print time, material laid, component dimensions, etc.).

The memory 330 may communicate with the controller 320 to send a command to the machine 100. The command may be at least one of a modulate torch translational speed 350 (e.g., increase torch translational speed, decrease torch translational speed, etc.), move torch 360, modulate melting power 370 (e.g., increase melting power, decrease melting power, etc.), and modulate material feed rate 380 (e.g., increase material feed rate, decrease material feed rate, etc.). Additionally or alternatively, the controller 320 may use the second sensor feedback 315 to determine optimum manufacturing parameters 390 (e.g., material feed rate, power, waveform, etc.). By way of example, different materials having varying wire diameters require varying manufacturing parameters. For example, materials having a larger diameter with a higher melting point may require at least one of (a) an increased melting power, (b) a faster torch speed, (c) a slower material feed rate, etc.

According to an exemplary embodiment, the controller 320 may use the first sensor feedback 310 to determine if the machine is meeting a space filling requirement. Traditionally, feed rate, layer height, and a distance between lines in a feed path are parameters that define a space filling requirement. A type of wire material being used, a power supplied to the torch, and a current component condition (e.g., temperature, etc.) may result in violation of the space filling requirement. For example, a high melting power could be expected to produce a hotter and more fluid melt pool, resulting in a shorter layer height that may be less than desired, thus controller 320 would decrease welding power. Likewise, a lower melting power could be expected to produce a colder and less fluid melt pool, resulting in an increased layer height greater than desired, thus controller 320 would increase welding power.

In some embodiments, the control system 300 may include a user interface, where the operator may view a status of the machine 100, and, in response, manually control the machine 100 to perform a specific operation. The user interface may include status data for the machine 100, such as (a) a manufacturing completion time, (b) a torch temperature, (c) a material status, (d) a torch speed, (e) a current manufacturing layer, etc. The operator may interact with the user interface to manually control, and/or override a current control.

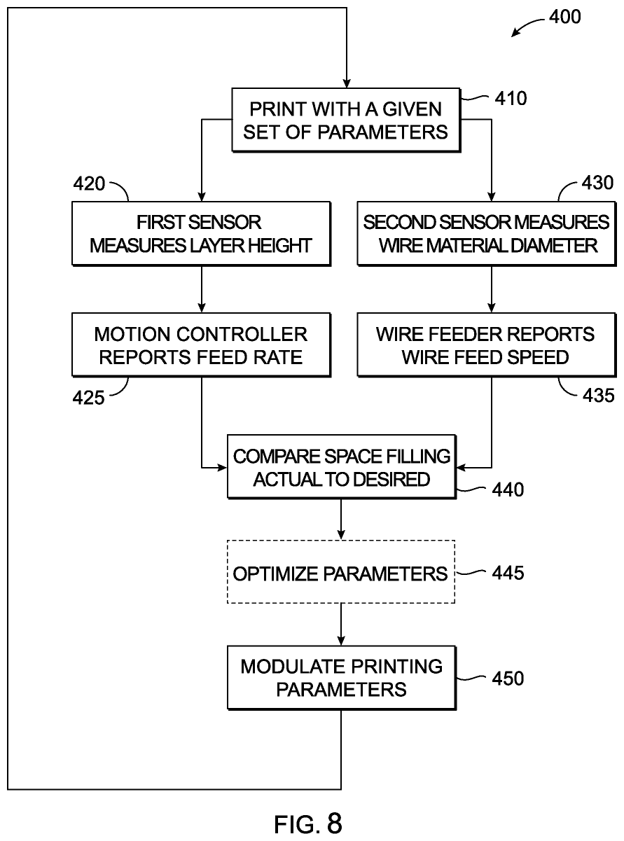

Referring now to FIG. 8, a method of controlling the wire additive manufacturing machine, referred to herein as method 400, is shown. While using a given set of parameters to print a component 410, both layer height is measured 420 and wire diameter is measured 430. The motion controller reports torch translational speed 425 and the wire feeder reports wire feed speed 435. In step 440, the machine controller compares the volume to be filled as defined by the tool path to the actual volume filled as defined by the measured outputs from the various machines and sensors 420, 425, 430 and 435. In step 450, the machine controller modulates at least one of motion controller feed rate, wire feed rate, melting power and melting power waveform based on the results of the space filling comparison.

As may be appreciated, printing parameters may vary with the composition and nature of the wire material being consumed by the system. The closed-loop control system (e.g., method 400) responds automatically to changes in the wire material, permitting an optional step, automatic determination of optimal printing parameters 445. Traditionally, when a wire material having different properties (e.g., composition, diameter, etc.) is initially tested, optimal printing parameters are determined iteratively on a trial-and-error basis. The automatic determination of optimal printing parameters 445 may be performed more quickly while using less wire material. Optimal parameters so determined may be stored and recalled as necessary.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “example” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other example embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. According to an example embodiment, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an example embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the torch 120 of the example embodiment described with reference to FIGS. 1-6 may be incorporated into the control system 300 of the example embodiment described with reference to FIG. 7. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A metal additive manufacturing machine, comprising:
a housing;
a torch coupled to the housing;
a media positioned beneath the torch and expanding over a print area, the media forming a flat or topographically featured structure;
a material positioned such that it is melted by the torch and configured to melt and form a layer of material onto the media;
a sensor coupled to the housing via a support and configured to measure a first data, the first data is a distance between an end of the torch and a component or media; and
a control system operably coupled to the sensor, the control system configured to receive the first data and compare the first data to a first data threshold;
wherein the control system sends a command to move the torch in a z-direction in response to the first data being outside of the first data threshold.

2. The machine of claim 1, further comprising a second sensor operably coupled to the control system and configured to measure a material diameter;
wherein the material diameter is provided to the control system; and
wherein the control system determines optimum manufacturing parameters based on the material diameter.

3. The machine of claim 1, further comprising an anchor at least partially disposed within the media and extending laterally from the media; and
wherein the material is at least partially layered on to the anchor to form the component with the anchor provided therein.

4. The machine of claim 1, wherein an inert gas is provided within the hollow portion of the torch; and
wherein the inert gas is outputted from the torch when the material is deposited to form a shielding zone.

5. The machine of claim 1, wherein the material is initially layered over the topographically featured structure to form a component that is initially in a deformed state;
wherein the component deforms into a target state as more material is layered onto the component.

6. The machine of claim 1, wherein in response to receiving the first data, the control system can control at least one of a material feed rate, a torch translational speed, a torch height, a melting power, and a melting power waveform.

7. The machine of claim 1, wherein the layer of material builds up to form the component, and wherein the component reverse deforms into a desired geometry.

8. The machine of claim 1, wherein a shape of topographically featured structure changes based on the determined component deformation from a simulation software.

9. The machine of claim 1, wherein the first data threshold is a minimum threshold.

10. A machine configured to produce a metal component, comprising:
a housing;
a torch disposed parallel to the housing and at least partially received within the housing;
a media positioned beneath the torch and expanding over a print area;
a material at least partially disposed within the torch such that the material melts and configured to melt and form onto the media; and
an anchor at least partially disposed within the media and the metal component, the anchor exposed laterally from the media;
wherein the material is layered onto the anchor and media, and wherein the anchor is separated between the media and the metal component when the machine is done printing.

11. The machine of claim 10, wherein the media forms topographic features on top of the print area; and
wherein the shape of topographic features changes based on a determined component deformation.

12. The machine of claim 10, wherein the material is initially layered over the topographically featured structure to form a component that is initially in a deformed state; and
wherein the component deforms into a target state as more material is layered onto the component.

13. The machine of claim 10, further comprising a control system operably coupled to the sensor, the control system configured to receive the first data and compare the first data to a first data threshold.

14. The machine of claim 13, wherein the control system sends a command to move the torch in a z-direction in response to the first data being outside of the first data threshold.

15. The machine of claim 13, wherein in response to receiving the first data, the control system can control at least one of a material feed rate, a torch translational speed, a torch height, a melting power, and a melting power waveform.

16. The machine of claim 14, wherein the first data threshold is a minimum threshold.

17. The machine of claim 10, further comprising a motion control system; and
wherein the torch is repositionable within the print area via the motion control system.

18. A method of controlling a wire arc additive manufacturing machine, comprising:
providing a wire material through a torch or orifice over a granular media;
melting the material with a torch onto the granular media;
translating the torch along a path to create a layer of material;
providing a first sensor positioned distal the torch and configured to measure a distance between the torch and the layer of material or media; and
providing the distance between the torch and the layer of material to a control system, and, in response, reposition the torch to maintain a minimum distance between the torch and the layer of material or media;
wherein the wire material is initially partially layered onto an anchor exposed through the granular media that becomes fused to the metal component, and wherein the anchor is cut from the metal component after the metal component is removed from the granular media.

19. The method of claim 18, further comprising:
providing a second sensor configured to measure a wire material diameter prior to providing the wire material through the torch;
wherein the control system modulates at least one of a motion controller feed rate, a wire feed rate, a melting power and a melting power waveform based on a comparison between a calculated space filling comparison and a measured space filling comparison.

20. The method of claim 19, wherein the control system modulates the motion controller feed rate, the wire feed rate, the melting power and the melting power waveform to determine optimum manufacturing parameters.
